(19) United States
(12) Patent Application Publication
(10) Pub. No.: US 2013/0148975 A1
(43) Pub. Date: Jun. 13, 2013

(54) MULTICHANNEL TRANSMITTER OPTICAL MODULE

(71) Applicants: Oh Kee KWON, Daejeon (KR); Young-Tak Han, Daejeon (KR); Chul-Wook Lee, Daejeon (KR); Dong-Hun Lee, Daejeon (KR); Young Ahn Leem, Daejeon (KR); Jang Uk Shin, Daejeon (KR); Sang Ho Park, Daejeon (KR); Yun C. Chung, Daejeon (KR); Yongsoon Baek, Daejeon (KR)

(72) Inventors: Oh Kee KWON, Daejeon (KR); Young-Tak Han, Daejeon (KR); Chul-Wook Lee, Daejeon (KR); Dong-Hun Lee, Daejeon (KR); Young Ahn Leem, Daejeon (KR); Jang Uk Shin, Daejeon (KR); Sang Ho Park, Daejeon (KR); Yun C. Chung, Daejeon (KR); Yongsoon Baek, Daejeon (KR)

(73) Assignee: ELECTRONICS AND TELECOMMUNICATIONS RESEARCH INSTITUTE, Daejeon (KR)

(21) Appl. No.: 13/585,537

(22) Filed: Aug. 14, 2012

(30) Foreign Application Priority Data
Dec. 12, 2011 (KR) 10-2011-0133028

(51) Int. Cl. H04B 10/14

(52) U.S. Cl. 398/116; 398/115

(57) ABSTRACT

Provided is a multichannel transmitter optical module which includes a plurality of light source units configured to generate light, a plurality of an electro-absorption modulators (EAMs) configured to modulate the generated light to an optical signal through a radio frequency (RF) signal, a plurality of RF transmission lines configured to apply the RF signal to the EAMs, and a combiner configured to combine the modulated optical signal. The RF transmission lines are connected to the EAMs in a traveling wave (TW) electrode manner. The multichannel transmitter optical module has alleviated crosstalk and is compactly integrated to have a small size.

### CROSS-REFERENCE TO RELATED APPLICATIONS

This US non-provisional patent application claims priority under 35 USC § 119 to Korean Patent Application No. 10-2011-0133028, filed on Dec. 12, 2011, the entirety of which is hereby incorporated by reference.

### BACKGROUND OF THE INVENTION

The present general inventive concept relates to multichannel transmitter optical modules and, more particularly, to a multichannel transmitter optical module using an electro-absorption modulated laser.

For long-haul transmission with high speed modulation (i.e., large modulation bandwidth), an electro-absorption modulated laser (hereinafter referred to as “EML”) is utilized in a transmitter optical module. In recent years, optical modules for multichannel transmission through a multichannel EML array have been developed to achieve high-capacity transmission.

However, unlike the case where a single channel EML is used in on-off keying (OOK) modulation, a multichannel array is used in modulation to cause crosstalk among the channels. The crosstalk roughly includes the crosstalk among the channels within the chip and the crosstalk among the feeders (i.e., wires) for feeding RF signals to an EML array. The crosstalk of the EML array chip may overcome by adjusting a distance between channels of the EML array, while the crosstalk occurring at the feeder is inconveniently overcome by introducing a separate package structure. Use of this package structure leads to increase in process cost, decrease in manufacturing yield, and increase in module size. Accordingly, there is a need for an improved transmitter optical module which is capable of eliminating such inefficiency.

### SUMMARY OF THE INVENTION

Embodiments of the inventive concept provide a multichannel transmitter optical unit.

According to an aspect of the inventive concept, the multichannel transmitter optical module may include a plurality of light source units configured to generate light; a plurality of an electro-absorption modulators (EAMs) configured to modulate the generated light to an optical signal through a radio frequency (RF) signal;

a plurality of RF transmission lines configured to apply the RF signal to the EAMs; and a combiner configured to combine the modulated optical signal. The RF transmission lines are connected to the EAMs in a traveling wave (TW) electrode manner.

In some embodiments, each of the RF transmission lines may include an RF input terminal connected to an RF feeder to receive the RF signal; and an RF output terminal connected to a matching resistor to output the RF signal. The RF input terminal may be disposed at the same side as the light source units.

In some embodiments, the RF output terminal may be disposed to a side perpendicular to the RF input terminal.

In some embodiments, the RF output terminals may be disposed to be symmetrically distributed to both the sides.

In some embodiments, each of the light source units may include a light source configured to generate light; and a monitor photodetector configured to monitor the generated light. The light source and the monitor photodetector may be connected by a passive waveguide.

In some embodiments, the light source may be a distributed feedback laser diode (DFB-LD) including an asymmetric diffraction grating.

In some embodiments, an optical waveguide may be inserted between the EAMs and the combiner. The optical waveguide may include a spot size converter.

In some embodiments, the optical waveguide may be formed at a tilted angle.

In some embodiments, the combiner may be a multi-mode interferometer (MMI)

In some embodiments, each of the RF transmission lines may include an RF input terminal connected to an RF feeder to receive the RF signal; and an RF output terminal connected to a matching resistor to output the RF signal. The RF input terminal may be disposed to be symmetrical with respect to a side perpendicular to the light source units.

In some embodiments, the RF output terminal may be disposed at a side opposite to the light source units.

In some embodiments, the matching resistor may be directly integrated to the RF output terminal.

### BRIEF DESCRIPTION OF THE DRAWINGS

The inventive concept will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concept.

FIG. 1 is a block diagram of a multichannel transmitter optical module according to an embodiment of the inventive concept.

FIG. 2 illustrates a multichannel transmitter optical module having a lumped electrode structure according to an embodiment of the inventive concept.

FIG. 3 illustrates a multichannel transmitter optical module according to an embodiment of the inventive concept.

FIG. 4 illustrates the arrangement when a feeder and a matching resistor are connected to the multichannel transmitter optical module in FIG. 3.

FIG. 5 is a graphic diagram illustrating RF response characteristics for a single channel in the multichannel transmitter optical module in FIG. 4.

FIG. 6 illustrates a multichannel transmitter optical module according to another embodiment of the inventive concept.

FIG. 7 illustrates the arrangement when a feeder is connected to the multichannel transmitter optical module in FIG. 6.

### DETAILED DESCRIPTION

The inventive concept will now be described more fully hereinafter with reference to the accompanying drawings, in which preferred embodiments of the inventive concept are shown. However, the inventive concept may be embodied in many different forms and should not be construed as limited to the embodiments set forth herein. Rather, these embodiments are provided so that this disclosure will be thorough and complete, and will fully convey the scope of the inventive concept to those skilled in the art. Like numbers refer to like elements throughout.

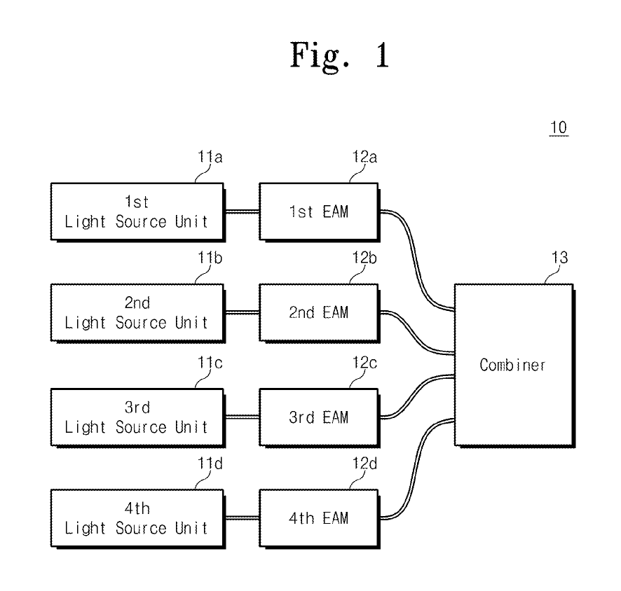

Reference is made to FIG. 1, which is a block diagram of a multichannel transmitter optical module 10 according to an embodiment of the inventive concept. The multichannel transmitter optical module 10 includes first to fourth light source units 11a-11d, first to fourth electro-absorption modulators (EAMs) 12a-12d, and a combiner 13.

In this embodiment, a four-channel transmitter optical module including four light source units and four EAMs will be described. However, the four-channel transmitter optical module is merely exemplary and the inventive concept is not limited to the number of channels. For example, the inventive concept may be applied to all transmitter optical modules having two or more channels.

In FIG. 1, light source units and EAMs of respective channels have the same configuration and operation principle. Hereinafter, a first light source and a first EAM constituting a first channel will be described below in detail.

A first light source unit 11a generates light. The generated light may be a continuous wave (CW). Alternatively, the generated light may be an optical pulse train. The first light source unit 11a may be a distributed feedback laser diode (DFB-LD).

The first EAM 12a modulates an optical signal using an RF signal applied from the first light source unit 11a. The first EAM 12a may be made of a material including a bulk, a multiple quantum well or a superlattice. The first EAM 12a has an optical absorption coefficient varying depending on an applied bias voltage. Thus, light passing through the first EAM 12a is modulated to an optical signal whose intensity varies depending on the RF signal applied to the first EAM 12a.

The first EAM 12a receives an RF signal in various manners. For example, the first EAM 12a may have a lumped electrode structure. The lumped electrode structure is a structure in which an RF signal is applied to one place of the first EAM 12a. That is, in the lumped electrode structure, the first EAM 12a is connected to an RF transmission line using only one wire. A multichannel transmitter optical module having a lumped electrode structure will be described in detail later with reference to FIG. 1. Although only the first light source unit 11a and the first EAM 12a have been described, the above contents are identically applied to the other light source units and the other EAMs.

The optical signal modulated by the first EAM 12a is transferred to the combiner 13. The combiner 13 combines modulated optical signals input from the first EAM 12a to the fourth EAM 12d. The combiner 13 outputs the combined multichannel optical signals to an external destination.

Reference is made to FIG. 1, which is a block diagram of a multichannel transmitter optical module 20 having a lumped electrode structure according to an embodiment of the inventive concept. The multichannel transmitter optical module 20 includes first to fourth light source units 21a-21d, first to fourth electrode-absorption modulators (EAMs) 22a-22d, a combiner 23, and first to fourth RF transmission lines 24a-24d. In this embodiment, a four-channel transmitter optical module including four light source units, four EAMs, and four RF transmission line will be described. However, the four-channel transmitter optical module is merely exemplary and the inventive concept is not limited to the number of channels. For example, the inventive concept may be applied to all transmitter optical modules including two channels or more.

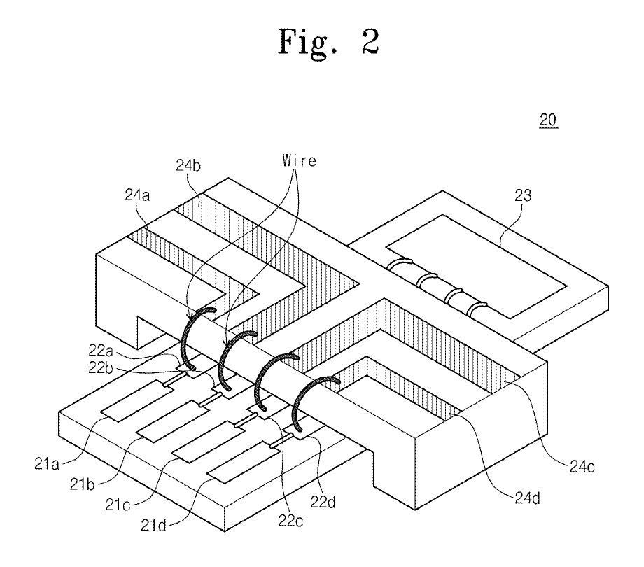

In FIG. 2, light source units and EAMs of respective channels have the same configuration and operation principle. Hereinafter, a first light source and a first EAM constituting a first channel will be described below in detail.

The first EAM 22a is connected to a first RF transmission line 24a through a wire. The first RF transmission line 24a serves to transmit an RF signal to the first EAM 22a. Although only the first RF transmission line 24a and the first EAM 22a have been described, the above contents are identically applied to the other RF transmission lines and the other EAMs.

The arrangement of an RF transmission line and a wire connecting the RF transmission line with an EAM is one of the factors for determining the size of a multichannel transmitter optical module. Each RF transmission line has an input terminal and an output terminal. Since a feeder is connected to an input terminal of an RF transmission line and a matching resistor is connected to an output terminal thereof, an area occupied by the RF transmission line is large. For this reason, the arrangement of the RF transmission line is significant in manufacturing a multichannel transmitter optical module.

In this embodiment, an RF transmission line is disposed on an upper layer over an EAM. Thus, a distance between the EAM and the RF transmission line is minimized and the EAM and a feeder of the RF transmission line are separated from each other. As a result, complexity caused by the wire and the feeder is reduced.

A multichannel transmitter optical module having a lumped electrode structure exhibits low optical signal modulation efficiency while using a traveling wave (TW) electrode structure. The TW electrode structure is a structure in which an RF signal passes through the entire EAM modulation electrode.

In the TW electrode structure, an EAM includes two different electrodes. One is an electrode receiving an RF signal from an RF transmission line, and the other is an electrode outputting the RF signal to the RF transmission line. Accordingly, if the TW electrode structure is used, two portions connecting an EAM and an RF transmission line are required to increase complexity. In order to overcome the disadvantage, the inventive concept provides a multichannel transmitter optical module with the arrangement to reduce the complexity caused by a feeder and a wire.

Reference is made to FIG. 1, which illustrates a multichannel transmitter optical module according to an embodiment of the inventive concept. The multichannel transmitter optical module includes first to fourth light source units 110a-110d, first to fourth EAMs 120a-120d, a combiner 130, first to fourth RF input terminals, first to fourth RF transmission lines 142a-142d, and first to RF output terminals 143a-143d. In this embodiment, a four-channel transmitter optical module will be described. However, the four-channel transmitter optical module is merely exemplary and the inventive concept is not limited to the number of channels. For example, the inventive concept may be applied to all transmitter optical modules including two channels or more.

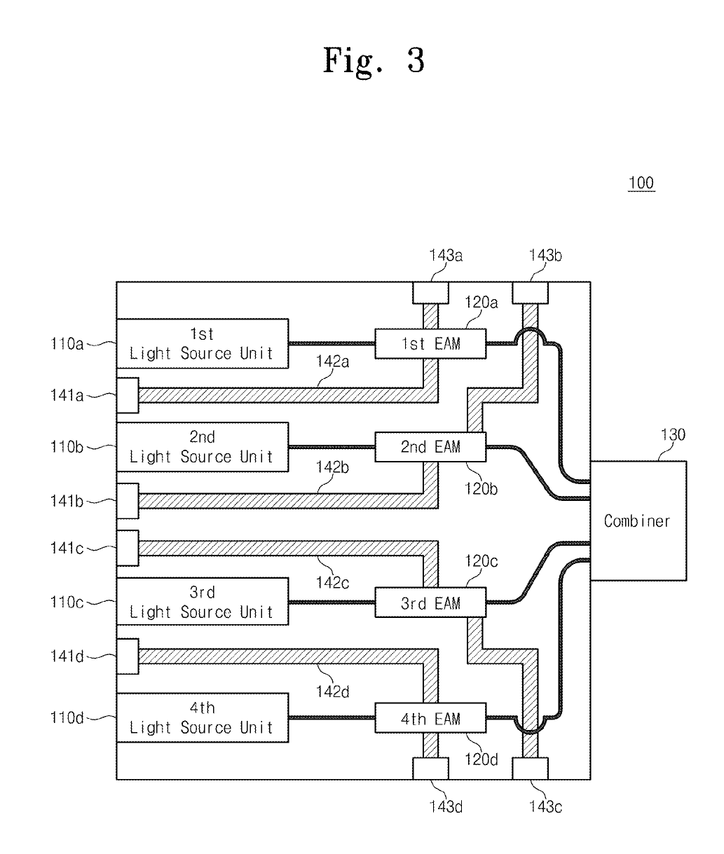

In FIG. 3, light source units and EAMs of respective channels have the same configuration and operation principle. Hereinafter, a first light source and a first EAM constituting a first channel will be described below in detail.

The first light source unit 110a may include a light source and a monitor photodetector (MPD). The light source generates light. The generated light may be a continuous wave (CW). Alternatively, the generated light may be an optical pulse train. The light source may be a distributed feedback laser diode (DFB-LD). The light source may include an asymmetric diffraction grating, which may improve light output intensity in a light output direction.

The monitor photodetector monitors the light generated from the light source. A passive waveguide may be inserted between the light source and the monitor photodetector. The passive waveguide serves to reduce electrical crosstalk that occurs when an optical signal is transmitted.

The light generated from the first light source unit 110a is modulated to an optical signal in the first EAM 120a through an RF signal. The first light source unit 110a and the first EAM 120a may be connected by the passive waveguide. The passive waveguide serves to reduce electrical crosstalk that occurs when an optical signal is transmitted. The light modulated in the first EAM 120a is transferred to the combiner 130. An optical waveguide may be inserted between the first EAM 120a and the combiner 130. The optical waveguide serves to improve transmission efficiency of the optical signal. The optical waveguide may include a spot size converter. The optical waveguide may be configured as a tilted waveguide to reduce loss caused by reflection of the optical signal.

The combiner 130 may be fabricated using indium phosphide (InP), silica, silicon or polymer. The combiner 130 may be in the form of a multi-mode interferometer (MMI), an arrayed waveguide grating (AWG) or a concave grating (CG).

The first RF input terminal 141a externally receives an RF signal through a feeder. The RF signal received through the first RF input terminal 141a is transmitted to the first RF output terminal 143a through a first RF transmission line 142a.

The first RF input terminal 141a and the first RF output terminal 143a may each be in the form of a ground coplanar waveguide (GCPW). The first RF transmission line 142a may include a top metal and a base metal. The top metal and the base metal are insulated by an insulating layer made of polyimide or benzocyclobutene (BCB).

The first RF output terminal 143a is connected to a matching resistor. The matching resistor serves to terminate the first RF transmission line 142a. The matching resistor may have a resistance of 50 ohms In a TW electrode structure, the first EAM 120a is connected to the first RF transmission line 142a for transmitting an RF through two portions to modulate the optical signal. Although only the first channel has been described, the above contents are identically applied to the other channels.

In order to decrease the size of a multichannel transmitter optical module, a feeder for feeding power to a light source unit and an EAM and a feeder for feeding an RF signal to an RF input terminal should have short lengths. A distance between the RF transmission line and the EAM should be short to decrease length of a wire. In addition, an RF output terminal should be aligned to decrease an area occupied by a matching resistor.

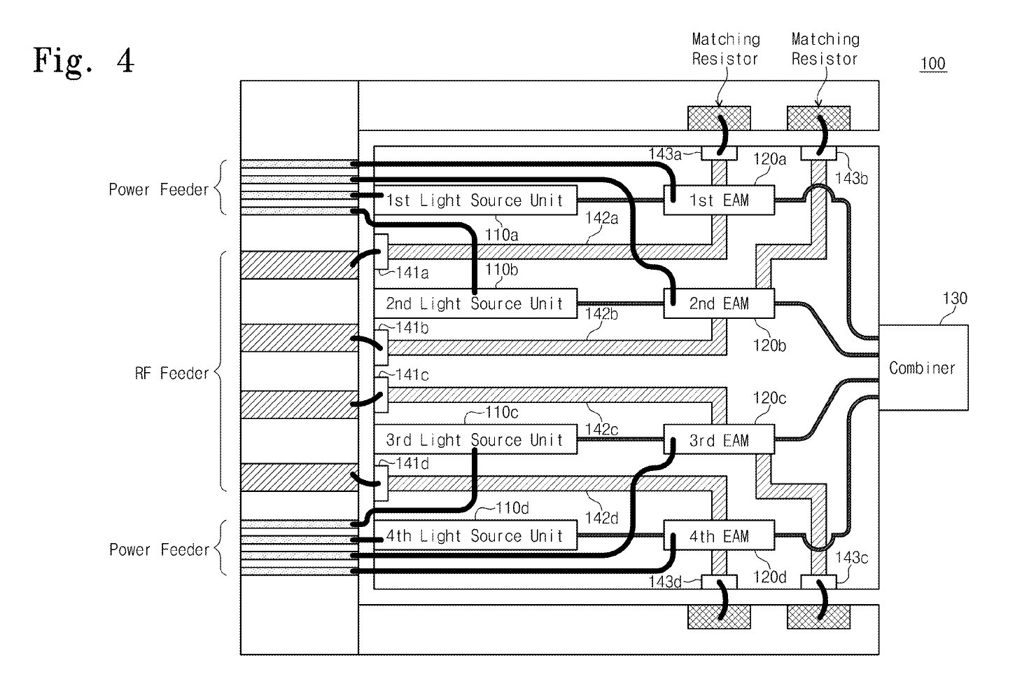

Reference is made to FIG. 4, which illustrates the arrangement when a feeder and a matching resistor are connected to the multichannel transmitter optical module 100 in FIG. 3. In the multichannel transmitter optical module 100, a distance between an RF feeder and an RF input terminal is short and constant in each channel. Thus, the length of a wire for providing an RF signal to the RF input terminal is minimized Additionally, light source unit and an RF transmission line are disposed adjacent to each other. Thus, the length of a wire for providing the RF signal to an EAM is minimized As a result, crosstalk caused by the RF signal is minimized

The multichannel transmitter optical module 100 has a vertically symmetrical structure. That is, channels of the multichannel transmitter optical module 100 are distributed to both the sides. Accordingly, since an RF output terminal is distributed to both the sides, a matching resistor is easily packaged in a small size.

Furthermore, all power feeders and all RF feeders are disposed at one side in the multichannel transmitter optical module 100. Thus, an external input terminal may be disposed at one place when an external element is connected to the multichannel transmitter optical module 100, which is convenient.

According to the above-described multichannel transmitter optical module 100 in FIG. 4, a wire decreases in length to alleviate crosstalk caused by an RF signal. In addition, channels are distributed to both the sides to easily package a matching resistor. In addition, all feeders are disposed at one side to easily connect an external element to the multichannel transmitter optical module 100. Furthermore, since an upper layer for forming an RF transmission line need not be formed, process cost is reduced to improve process efficiency.

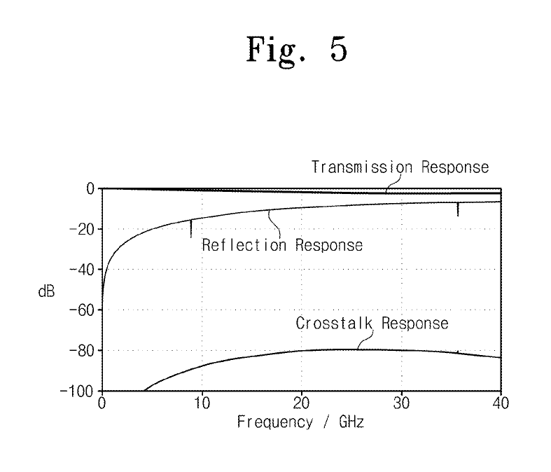

Reference is made to FIG. 5, which is a graphic diagram illustrating RF response characteristics for a single channel in the multichannel transmitter optical module 100 in FIG. 4. In the graph in FIG. 5, a horizontal axis represents a frequency of an RF and a vertical axis represents the dB unit magnitude of a response. In the graph in FIG. 5, a distance between channels of the multichannel transmitter optical module 100 was calculated to be 40 um.

In FIG. 5, it can be confirmed that −3 dB bandwidth of a transmission response is 40 GHz. Additionally, it can be confirmed that −10 dB frequency of a reflection response is 20 GHz and, at this point, a crosstalk level is −80 dB. That is, a multichannel transmitter optical module with a channel-to-channel distance of 400 um or more theoretically has crosstalk of −80 dB or less. When the channel-to-channel distance is designed to be 400 um, a device length may be about 2.5 mm. Thus, the multichannel optical module 100 may be packaged in a small size while having low crosstalk.

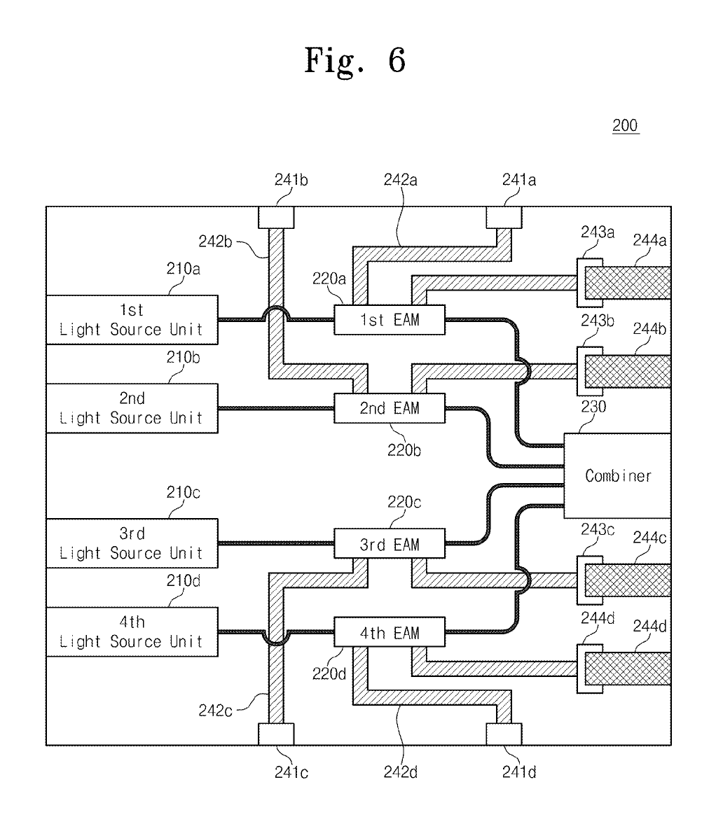

Reference is made to FIG. 6, which illustrates a multichannel transmitter optical module 200 according to another embodiment of the inventive concept. The multichannel transmitter optical module 200 is different in arrangement of elements than the multichannel transmitter optical module 100 in FIG. 3.

In the multichannel transmitter optical module 200, light source units 210a-210d and RF input terminals 241a-241d are separately arranged. The RF input terminals 241a-241d are arranged to be distributed to both sides. RF output terminals 243a-243d are arranged at the side opposite to the light source units 210a-210de. Thus, RF transmission lines 242a-242d are arranged to be distributed to both the sides, which provides a space in which a combiner 230 and matching resistors 244a-244d may be integrated.

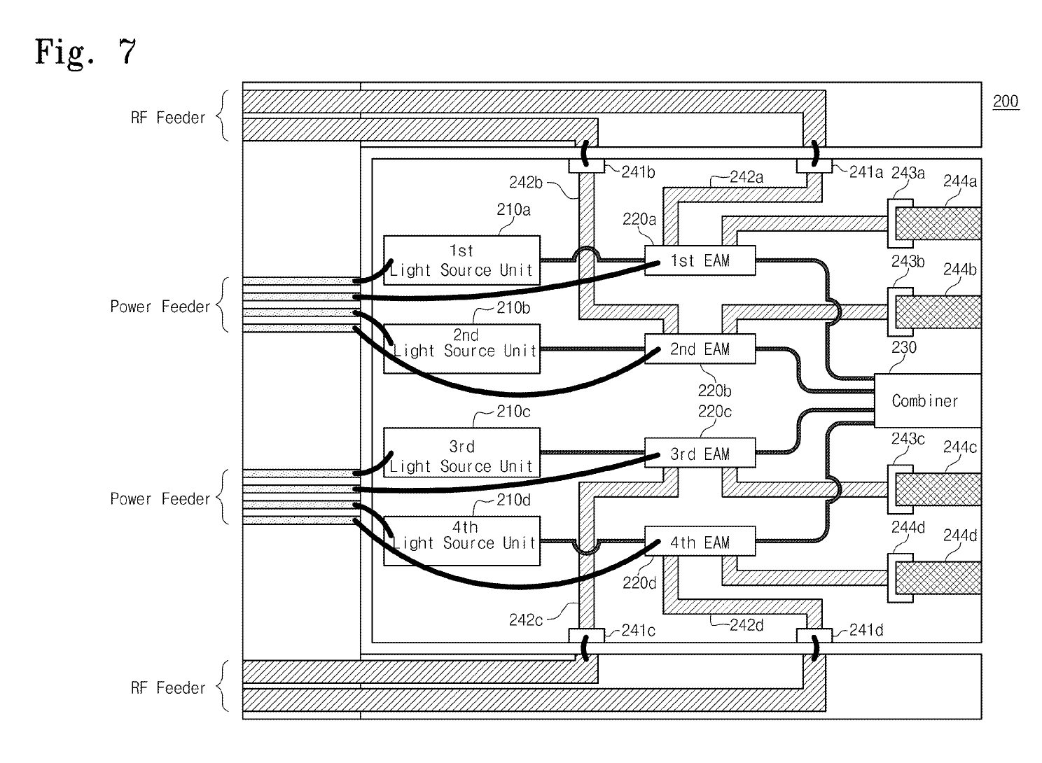

Reference is made to FIG. 7, which illustrates the arrangement when a feeder is connected to the multichannel transmitter optical module 200 in FIG. 6. In the multichannel transmitter optical module 200, RF feeders and power feeders are separated from each other. If distances between the RF feeders and RF input terminals 241a-241d are short, they are constant in respective channels. Thus, the length of a wire for providing an RF signal to the RF input terminals 241a-241d is minimized Additionally, light source units 210a-210d, EAMs 220a-220d, and RF transmission lines 242a-242d are all distributed to both sides. Accordingly, since the light source units 210a-210d, the EAMs 220a-220d, and the RF transmission lines 242a-242d are disposed adjacent to each other, the length of a wire for providing the RF signal to the EAM 220a-220d is minimized As a result, crosstalk caused by the RF signal is minimized

Moreover, in the multichannel transmitter optical module 200, the RF transmission lines 242a-24d are distributed to both the sides to provide a space in which a combiner 230 may be embedded on the same package. Thus, an unwanted sub-mount for forming the combiner 230 may be removed to decrease the size of the multichannel transmitter optical module 200.

Furthermore, in the multichannel transmitter optical module 200, the RF transmission lines 242a-242d are distributed to both the sides to provide a space in which matching resistors 244a-244d may be embedded on the same package. Thus, unlike the multichannel transmitter optical module 100 in which RF output terminals 243a-243d are connected to an external matching resistor through a wire, the matching resistors 244a-244d may be directed integrated. Thus, an unwanted sub-mount for forming the matching resistors 244a-244d may be removed to decrease the size of the multichannel transmitter optical module 200.

As described so far, a multichannel transmitter optical module according to the inventive concept has alleviated crosstalk and is compactly integrated to have a small size.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A multichannel transmitter optical module comprising:
a plurality of light source units configured to generate light;
a plurality of an electro-absorption modulators (EAMs) configured to modulate the generated light to an optical signal through a radio frequency (RF) signal;
a plurality of RF transmission lines configured to apply the RF signal to the EAMs; and
a combiner configured to combine the modulated optical signal,
wherein the RF transmission lines are connected to the EAMs in a traveling wave (TW) electrode manner.

2. The multichannel transmitter optical module of claim 1, wherein each of the RF transmission lines comprises:
an RF input terminal connected to an RF feeder to receive the RF signal; and
an RF output terminal connected to a matching resistor to output the RF signal,
wherein the RF input terminal is disposed at the same side as the light source units.

3. The multichannel transmitter optical module of claim 2, wherein the RF output terminal is disposed to a side perpendicular to the RF input terminal.

4. The multichannel transmitter optical module of claim 3, wherein the RF output terminals are disposed to be symmetrically distributed to both the sides.

5. The multichannel transmitter optical module of claim 1, wherein each of the light source units comprises:
a light source configured to generate light; and
a monitor photodetector configured to monitor the generated light,
wherein the light source and the monitor photodetector are connected by a passive waveguide.

6. The multichannel transmitter optical module of claim 5, wherein the light source is a distributed feedback laser diode (DFB-LD) including an asymmetric diffraction grating.

7. The multichannel transmitter optical module of claim 1, wherein an optical waveguide is inserted between the EAMs and the combiner, the optical waveguide including a spot size converter.

8. The multichannel transmitter optical module of claim 7, wherein the optical waveguide is formed at a tilted angle.

9. The multichannel transmitter optical module of claim 1, wherein the combiner is a multi-mode interferometer (MMI)

10. The multichannel transmitter optical module of claim 1, wherein each of the RF transmission lines comprises:
an RF input terminal connected to an RF feeder to receive the RF signal; and
an RF output terminal connected to a matching resistor to output the RF signal,
wherein the RF input terminal is disposed to be symmetrical with respect to a side perpendicular to the light source units.

11. The multichannel transmitter optical module of claim 10, wherein the RF output terminal is disposed at a side opposite to the light source units.

12. The multichannel transmitter optical module of claim 11, wherein the matching resistor is directly integrated to the RF output terminal.

13. The multichannel transmitter optical module of claim 11, wherein the combiner is embedded internally at the same side as the RF output terminal
